(19) United States
(12) Patent Application Publication
(10) Pub. No.: US 2013/0334781 A1
(43) Pub. Date: Dec. 19, 2013

(54) Infant Stroller and Swing Combination

(71) Applicant: Jeff Mills, Austin, TX (US)

(72) Inventor: Jeff Mills, Austin, TX (US)

(21) Appl. No.: 13/901,066

(22) Filed: May 23, 2013

Related U.S. Application Data
(60) Provisional application No. 61/659,275, filed on Jun. 13, 2012.

(51) Int. Cl. A63G 9/02; B62B 7/04

(52) U.S. Cl. CPC A63G 9/02; B62B 7/04
USPC 280/47.41

(57) ABSTRACT

A stroller is provided which includes a chassis having first and second opposing frame elements; a seat suspended from said chassis by way of first and second support elements, wherein said seat includes upper and lower portions and is adapted to accommodate a child such that the back of the child rests against the upper portion and such that the legs of the child rest against the lower portion, wherein said first and second support elements are rotatably attached to said first and second frame elements, and wherein said first support element extends under said lower portion of said seat; and a motor which rotates said first support element.

### CROSS-REFERENCE TO RELATED APPLICATIONS

This application claims priority U.S. Ser. No. 61/659,275 (Mills), entitled “Infant Stroller and Swing Combination”, which was filed on Jun. 13, 2012, and which is incorporated herein by reference in its entirety.

### FIELD OF THE DISCLOSURE

The present disclosure relates generally to infant strollers, and more particularly to infant strollers that are also adapted to function as a swing.

### BACKGROUND OF THE DISCLOSURE

Baby carriages or strollers are well known and have a long history in modern society. Indeed, the first stroller was invented in 1733 by the English architect William Kent for use by the children of the 3^{rd} Duke of Devonshire. Over the years, various improvements have been made to these devices. Many of these improvements have been concerned with making these devices more functional, durable, lighter, easier to manufacture, or easier to transport.

U.S. Pat. No. 6,250,654 (Willis) discloses an example of a more recent stroller. The device depicted therein is a car seat/stroller assembly with a frame that pivotally accepts an infant car seat. Once the car seat is positioned in the frame, it can rock freely in a back-and-forth motion. Other examples or strollers which have a similar functionality may be found in U.S. Pat. No. 706,448 (Pender), U.S. Pat. No. 1,480,451 (Koch), U.S. Pat. No. 1,508,500 (Bingen et al.), U.S. Pat. No. 3,564,626 (Nelson), U.S. Pat. No. 5,099,528 (Wadman), U.S. Pat. No. 5,987,665 (Simantob et al.), U.S. Pat. No. 6,250,654 (Willis), U.S. Pat. No. 7,037,205 (Bowman), U.S. Pat. No. 7,100,724 (Haigh), U.S. Pat. No. 7,497,461 (Emerson), and U.S. D156,390 (Wenpetren).

### BRIEF DESCRIPTION OF THE DRAWINGS

FIGS. 1-2 are illustrations of a prior art stroller.

FIGS. 3-6 are illustrations of a first embodiment of a stroller in accordance with the teachings herein.

FIG. 7 is an illustration of a second embodiment of a stroller in accordance with the teachings herein.

FIG. 8 is an illustration showing the manner in which the first set of support elements attaches the seat to the chassis in the first and second embodiments embodiments.

FIG. 9 is an illustration showing the manner in which the second support element attaches the seat to the chassis in the first and second embodiments embodiments.

FIG. 10 is a cross-sectional illustration taken along LINE 10-10 of FIG. 9.

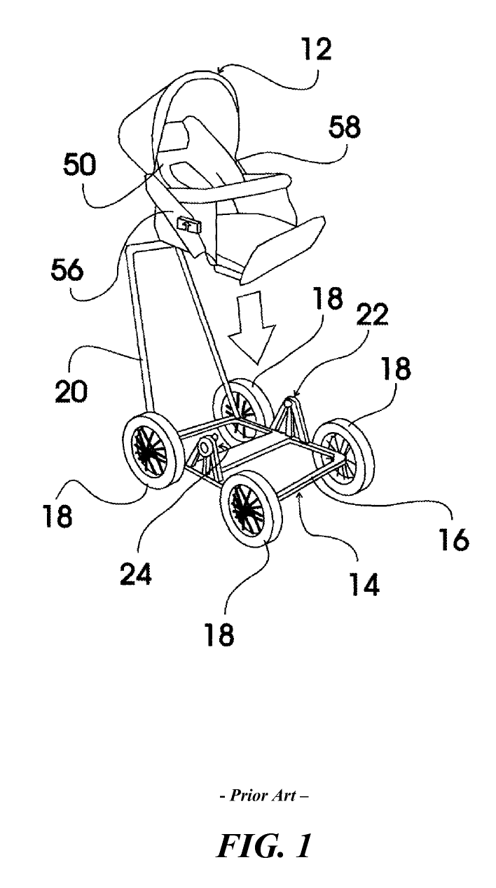

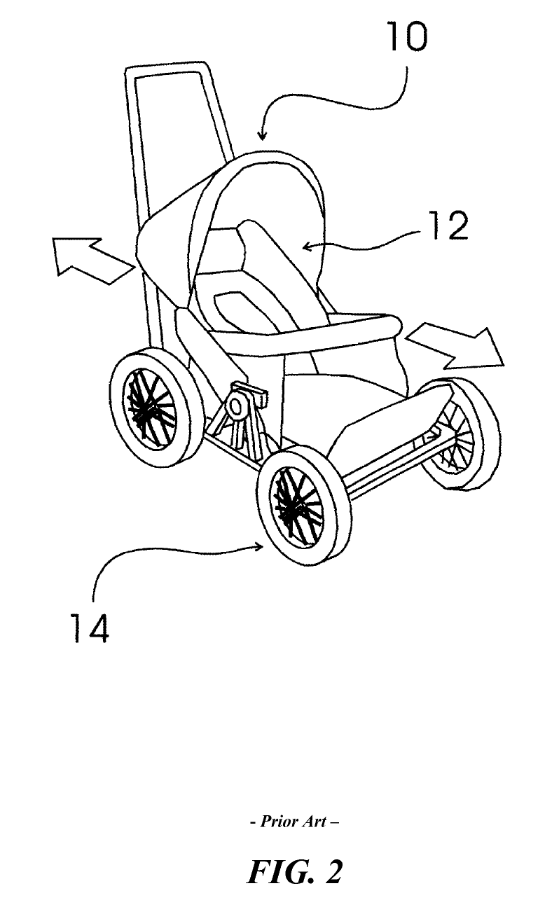

### SUMMARY OF THE DISCLOSURE

In one aspect, a stroller is provided which comprises (a) a chassis having first and second opposing frame elements; (b) a seat suspended from said chassis by way of first and second support elements, wherein said seat includes upper and lower portions and is adapted to accommodate a child such that the back of the child rests against the upper portion and such that the legs of the child rest against the lower portion, wherein said first and second support elements are rotatably attached to said first and second frame elements, and wherein said first support element extends under said lower portion of said seat; and (c) a motor which rotates said first support element.

### DETAILED DESCRIPTION

While the various devices disclosed in the prior art may be suitable for their intended purposes, these devices also suffer from various infirmities. In particular, many of these devices require manual operation, and hence are not well suited to hands-free operation by the caregiver of an infant. Other devices of this type are constructed as rocker/stroller combinations whose operation depends on the surface the device is positioned on. Still others are unduly complicated and difficult or expensive to manufacture. Furthermore, some devices, such as the device depicted in U.S. Pat. No. 6,250,654 (Willis), have an axis of rotation that is at or below the body of the infant. Such a disposition of the axis of rotation produces a rocking motion, rather than a swinging motion, that may be less conducive to relaxation for some infants.

It has now been found that the foregoing infirmities may be overcome with a stroller of the type disclosed herein. In a preferred embodiment, this stroller has a seat which swings about an axis of rotation which is disposed above the body of the infant, and preferably at the height of a crossbar which extends over the seat. Unlike the device of U.S. Pat. No. 6,250,654 (Willis), in which the axis of rotation is disposed at or below the body of the infant and hence produces a rocking motion, this disposition of the axis of rotation produces a swinging motion which is deemed more suitable to relaxation for some infants. It will be appreciated that this design allows the swinging motion of the seat to be decoupled from the nature of the surface the device is positioned upon. Moreover, this construction provides a stroller that provides a swinging motion and that is amenable to an uncomplicated design which may be operated easily and manufactured inexpensively.

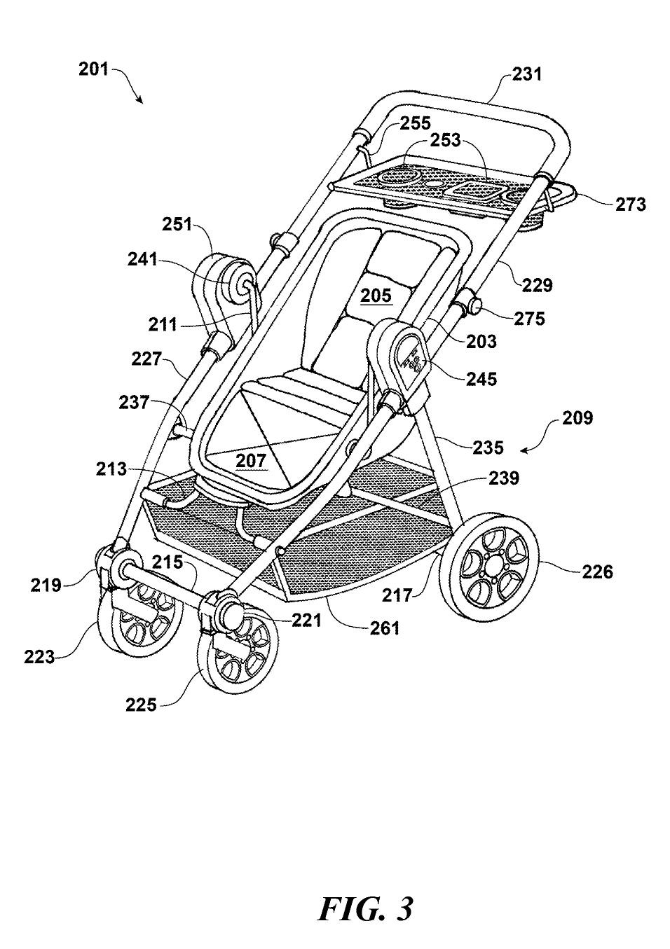

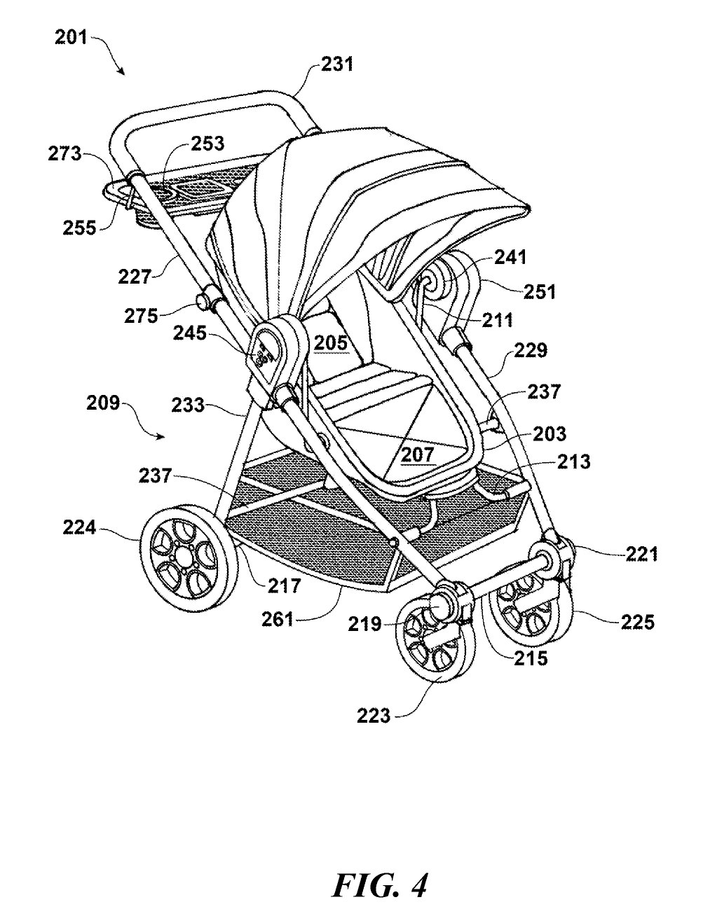

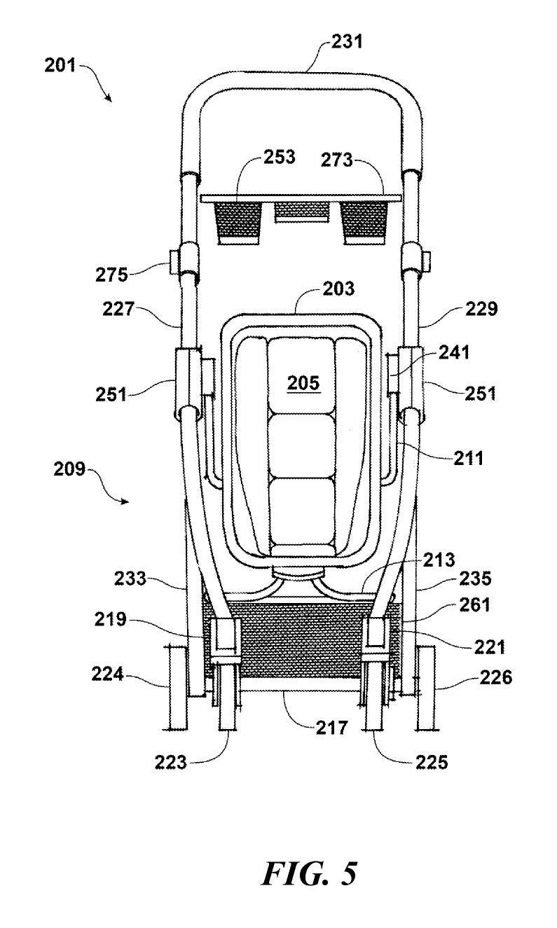

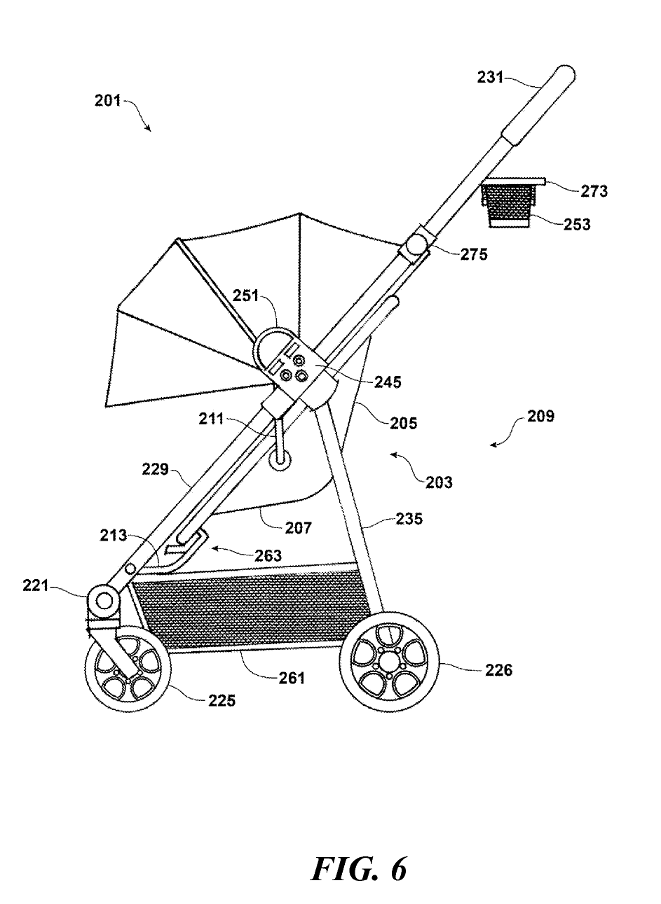

FIGS. 3-6 show a particular, non-limiting embodiment of a stroller in accordance with the teachings herein. As seen therein, the stroller 201 includes a seat 203 which includes an upper portion 205 and a lower portion 207 and which is mounted on a chassis 209 by way of first 211 and second 213 sets of support elements.

The stroller 201 is equipped with a front axle 215 and a rear axle 217. The front axle 215 terminates on a first end in a first joint 219, and terminates on a second end in a second joint 221. A first wheel 223 depends from the first joint 219, and a second wheel 225 depends from the second joint 221. In some embodiments, the first 219 and/or second 221 joints may be equipped with manually activated wheel locks or other such devices that allow the stroller to remain stationary on a sloped surface. The rear axle 217 has third 224 and fourth 226 wheels attached thereto.

The chassis 209 includes first 227 and second 229 opposing, and preferably complimentary shaped, telescopic frame elements which may be fixed at a particular length by way of a set of fasteners 275. The fasteners 275 may be spring-activated protrusions which engage a series of apertures in the length of the first 227 and second 229 frame elements, or may be threaded fasteners. The first 227 and second 229 frame elements are adjoined on a first end by way of a handle 231, and are adjoined on a second end by the front axle 215 by way of the first 219 and second 221 joints, respectively. The chassis 209 further comprises first 233 and second 235 struts. A first end of the first strut 233 is attached to the first frame element 227, and a second end of the first strut 233 is attached to the rear axle 217. Similarly, a first end of the second strut 235 is attached to the second frame element 229, and a second end of the second strut 235 is attached to the rear axle 217.

The chassis 209 also comprises first 237 and second 239 crossbars. A first end of the first crossbar 237 is attached to the first frame element 227, and a second end of the first crossbar 237 is attached to the first strut 233. Similarly, a first end of the second crossbar 239 is attached to the second frame element 229, and a second end of the second crossbar 239 is attached to the second strut 235.

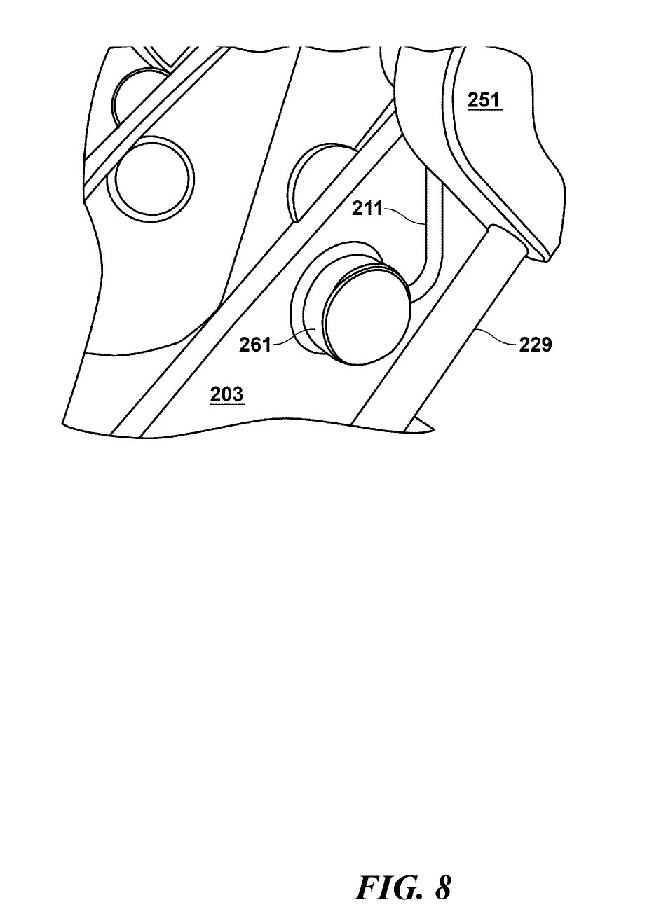

Each of the first support elements 211 are generally S-shaped, and include a first end which is inserted into an aperture in a hub 261 (see FIG. 8) disposed on a side of the seat 203, and a second end disposed in an aperture in a rotatable hub 241 that is driven by one of the motors 251. The particular embodiment depicted includes first and second motors 251 which are mounted, respectively, on the first 227 and second 229 frame elements. However, in some embodiments, only a single motor 251 may be utilized to drive one of the support elements 211.

A control interface 245 which is preferably equipped with a display and keypad is provided on the outside surface of one or both motors 251, and may be utilized to control the operation of the motor 251. The control interface 245 may be equipped with suitable logic, in the form of software or hardware, so that it is programmable and/or capable of implementing various modes of operation. For example, the control interface 251 may be adapted to swing the seat 203 in a slow, rhythmic manner so as to induce sleep, or with gradually reducing or increasing frequency.

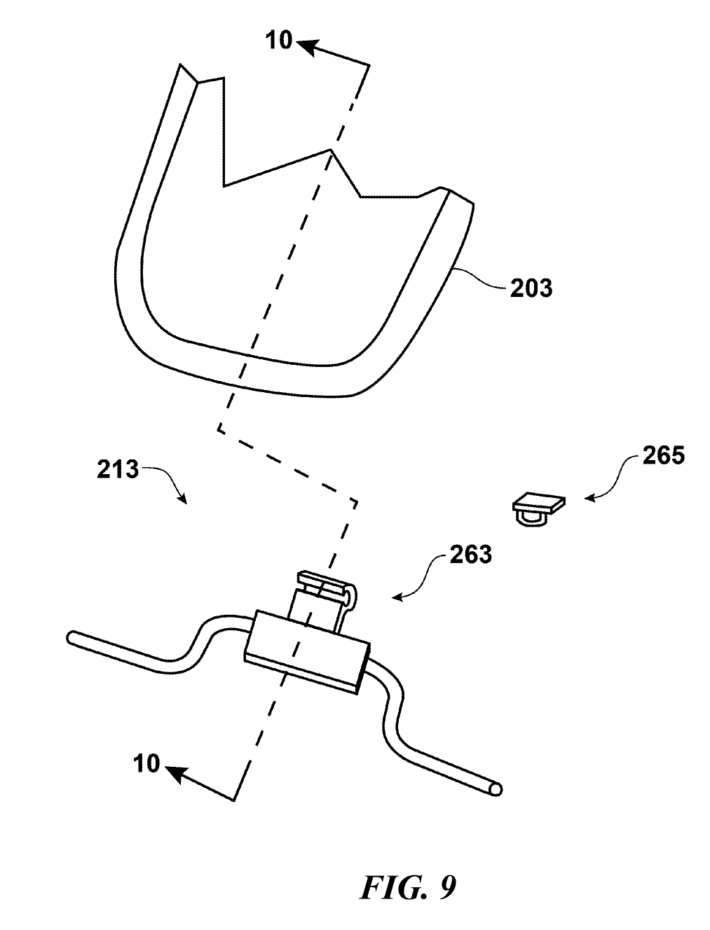

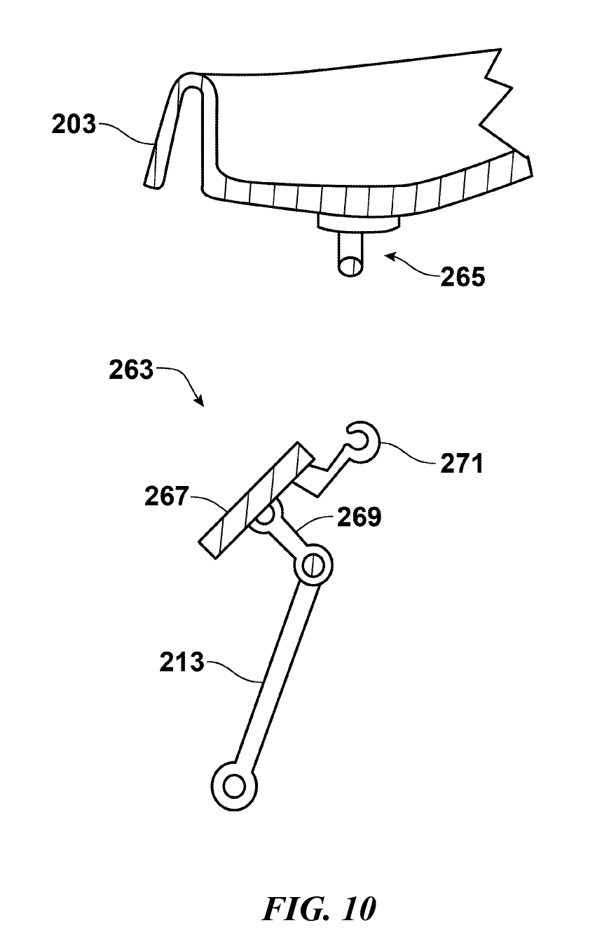

The configuration of the second support element 213 may be further appreciated with respect to FIGS. 9-10. As seen therein, the second support element 213 is generally U-shaped in geometry, and has a first end which is rotatably connected to the first frame element 227, and a second end which is rotatably connected to the second frame element 229. These rotatable connections may be implemented by way of a ball bearing assembly, a low friction coupler, or by other suitable means. The central portion of the second support element 213 (which is obscured by fabric in the views of FIGS. 3-5) is secured to the seat 203 by way of a coupler 263 which releasably engages a latch 265 attached to the underside of the seat 203. The coupler 263 includes a platform 267 (see FIG. 10) which is rotatably connected to the second support element 213 by way of a connector 269. A hook 271 is attached to the platform 267 and releasably engages the latch 265. Of course, it will be appreciated that various other means may be utilized to attach the second support element 213 to the seat 203.

The stroller 201 in this particular embodiment is further equipped with a tray 273. The tray 273 is provided with a series of indentations 253 adapted to hold beverages (e.g., bottles) or other such items. The tray 273 depends from the first 227 and second 229 frame elements by way of connectors 255. The connectors 255 are rotatably connected to the first 227 and second 229 frame elements in such a way that the tray 273 is maintained in a horizontal position by gravity independently of the orientation of the stroller 201.

The stroller of FIGS. 3-6 is further equipped with a storage compartment 261, which may be made out of a mesh, cloth or other suitable materials. Two corners of the storage compartment 261 are attached to the first 227 and second 229 frame elements, and two corners are attached to the first 233 and second 235 struts.

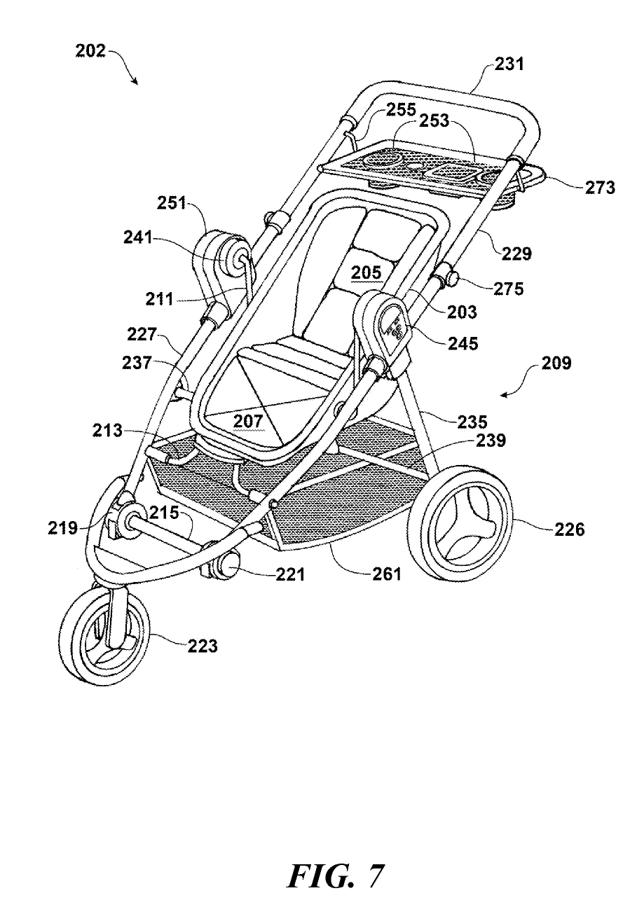

FIG. 7 illustrates a second particular, non-limiting embodiment of a stroller in accordance with the teachings herein. The stroller 202 depicted is similar in most respects to the first embodiment, but has a three-wheel configuration which may be more conducive to use in conjunction with certain activities, such as jogging. The wheels on the stroller 302 in this embodiment are preferably larger in diameter than the stroller 301 of the first embodiment, and are preferably mounted via quick disconnect levers.

The stroller 201 of the first embodiment and the stroller 302 of the second embodiment have numerous advantages. For example, the configurations of the first 211 and second 213 support elements allow the seat 203 to be readily removed from the chassis and reattached in the opposite orientation (e.g., facing backwards instead of forwards).

Several variations and modifications are possible to the foregoing embodiments. For example, the seat 203 may be replaced with a larger (preferably non-swingable) seat that attaches to the existing chassis 209. This feature allows the stroller to be modified to accommodate a larger child so that the stroller does not have to be replaced as the child grows.

Moreover, in some embodiments, the motor 251 may be battery powered. In such embodiments, a gearing mechanism may be provided which is activated by the motion of the stroller wheels, and which recharges the batteries which power the motor 251. This feature allows the batteries to be recharged through normal use of the stroller.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A stroller, comprising:
a chassis having first and second opposing frame elements;
a seat suspended from said chassis by way of first and second support elements, wherein said seat includes upper and lower portions and is adapted to accommodate a child such that the back of the child rests against the upper portion and such that the legs of the child rest against the lower portion, wherein said first and second support elements are rotatably attached to said first and second frame elements, and wherein said first support element extends under said lower portion of said seat; and
a motor which rotates said first support element.

2. The stroller of claim 1, wherein said first support element is rotatably attached to first and second pivots disposed, respectively, on said first and second frame elements.

3. The stroller of claim 1, wherein said first support element includes first and second opposing portions which are connected by a third portion, wherein said first and second portions are rotatably attached to said first and second frame elements, respectively, and wherein said third portion extends underneath said lower portion of said seat.

4. The stroller of claim 1, wherein said first support element is U-shaped.

5. The stroller of claim 1, wherein said second support element includes first and second arcuate portions.

6. The stroller of claim 5, wherein said second support element is attached to the lower portion of said seat.

7. The stroller of claim 1, wherein said first support element extends under the middle of the lower portion of said seat, and wherein said second support element is attached to one end of said seat.

8. The stroller of claim 1, wherein said motor is mounted on first and second opposing frame elements.

9. The stroller of claim 1, wherein said motor includes first and second motors mounted, respectively, on first and second opposing frame elements.

10. The stroller of claim 1, wherein said seat has an edge that lies in a plane, wherein said seat is equipped with cushioning which lies on a first side of said plane, and wherein said motor lies on a second side of said plane.

11. The stroller of claim 1, further comprising a handle attached to a first end of said first and second frame elements.

12. The stroller of claim 11, further comprising a first axle having first and second joints disposed on first and second ends thereof

13. The stroller of claim 12, wherein a second end of said first frame element is attached to said first joint, and wherein a second end of said second frame element is attached to said second joint.

14. The stroller of claim 13, further comprising first and second wheels attached, respectively, to first and second joints.

15. The stroller of claim 14, wherein said first and second wheels include wheel locks.

16. The stroller of claim 1, further comprising a second axle having third and fourth wheels disposed, respectively, on first and second ends thereof.

17. The stroller of claim 16, further comprising a first strut having a first end which is attached to said first frame element, and having a second end which is attached to said second axle.

18. The stroller of claim 17, further comprising a second strut having a first end which is attached to said second frame element, and having a second end which is attached to said second axle.

19. The stroller of claim 16, further comprising:
a first crossbar having a first end which is attached to said first frame element, wherein said first crossbar has a second end which is attached to said first strut; and
a second crossbar having a first end which is attached to said second frame element, wherein said second crossbar has a second end which is attached to said second strut.

20. The stroller of claim 1, wherein said stroller is transformable between a first state and a second state, wherein said second state is in a more compact arrangement in said second state as compared to said first state, and further comprising a spring activated lock disposed on said first frame element which locks the stroller in said first state, and wherein said lock further includes a button which may be pressed to disengage the lock, thus allowing said stroller to be placed in said second state.
